(19) United States
(12) Patent Application Publication
(10) Pub. No.: US 2018/0136350 A1
(43) Pub. Date: May 17, 2018

(54) METHOD AND SYSTEM FOR THE MULTIMODAL AND MULTISCALE ANALYSIS OF GEOPHYSICAL DATA BY TRANSFORMATION INTO MUSICAL ATTRIBUTES

(71) Applicant: ENI S.p.A., Roma (IT)

(72) Inventors: Paolo DELL'AVERSANA, Salsomaggiore Terme (PR) (IT); Gianluca GABBRIELLINI, Osnago (LC) (IT); Alfonso AMENDOLA, Ogliastro Cilento (SA) (IT)

(73) Assignee: ENI S.p.A., Roma (IT)

(21) Appl. No.: 15/564,268

(22) PCT Filed: Apr. 6, 2016
(86) PCT No.: PCT/IB2016/051941

§ 371 Date: Oct. 4, 2017

(30) Foreign Application Priority Data
Apr. 7, 2015 (IT) 102015000011071

(51) Int. Cl. G01V 1/30; G01V 1/34; G01V 1/32

(52) U.S. Cl. CPC G01V 1/30; G01V 1/32; G01V 1/345

(57) ABSTRACT

A multimodal and multi-scale analysis method of geophysical data is described. The method includes the steps of: acquisition of a plurality of geophysical and/or seismic data or signals extracted from a predefined geological context; recording the data or signals in a digital format on a vector; transformation or conversion of the data or signals into corresponding digital images; transformation or conversion of the data or signals into corresponding sound data available in standard digital musical formats and processing the data or signals in relation to the time and relative frequency content; creation of sound attributes suitable for identifying and characterizing specific geo-musical anomalies, starting from the sound data; and effecting an audio-video comparative analysis, so as to associate, with one or more digital images of a certain geophysical signal, one or more of the sound data associated with the digital images.

The present invention relates to a method and system for the multimodal and multiscale analysis of geophysical data by the transformation of said geophysical data into musical attributes.

The analysis of geophysical data in general, and in particular, of geophysical and/or seismic data relating to wells for the extraction of hydrocarbons (logging) is usually effected through various types of procedures which transform the experimental responses (observations) into models of physical parameters (propagation rate of the seismic waves, electrical resistivity, density, acoustic impedance and derivative attributes, and so forth). These models are generally represented as two-dimensional sections, such as, for example, a seismic section, or as parametric volumes such as, for example, a three-dimensional model of resistivity or seismic velocities.

The well data acquired through extremely dense samplings, such as, for example sonic logs or resistivity, or acquired with other methods such as VSP (acronym of “Vertical Seismic Profile”, which uses seismic sources on the surface and geophones in the well), cross-holes (sources and receivers distributed in two or more wells) and yet more, also provide subsoil models on a more detailed scale with respect to the observations effected on the surface (for example models relating to porosity, saturation, permeability of a geological formation containing hydrocarbons). In any case, all of these types of subsoil models are normally represented as images (1D, 2D, 3D and also 4D, adding the time factor). The entire flow of data processing is therefore aimed at optimizing the resolution power of the images themselves.

In spite of enormous progress made in the field of processing, modelling and representation by means of images of geophysical data of the surface and/or well, in many cases there are intrinsic problems of resolution and interpretation linked to a series of factors that can be grouped into various main categories:
intrinsic limitations relating to the physics of the data and/or the technologies used for the acquisition of the same data;
limitations of visual representation of the imaging techniques;
physiological limitations relating to the perceptual and cognitive abilities of the individuals who analyze and interpret said data.

Some authors have recently proposed sonification techniques of well data (Gabriel Quintero, “Sonification of oil and gas wireline well logs”, International Conference on Auditory Display, Jul. 6-10, 2013). This approach allows a transformation of the log data into sounds in order to add a sound perception of the geophysical information.

Like other previous attempts at sonification of geophysical data, however, the result is affected by limitations of resolution and accuracy.

In procedures of the known type, in fact, the transformation of geophysical data to sound never accurately reflects the information content owned by the entire frequency spectrum that characterizes the starting geophysical data. In other words, although sonification is a technique already present in literature, this technique is never effected with the required accuracy and precision.

The objective of the present invention is therefore to provide a method and system for the multimodal and multiscale analysis of geophysical data, based on the transformation of said geophysical data into musical attributes, which are capable of solving the drawbacks of the known art indicated above, allowing, in particular, to overcome current limitations of the representative, cognitive type and relating to the accuracy of geophysical data themselves.

This and other objectives according to the present invention are achieved by providing a method and system for the multimodal and multiscale analysis of geophysical data as specified in the independent claims.

Further characteristics of the invention are indicated in the dependent claims, which are an integral part of the present description.

In general, the method for the multimodal and multiscale analysis of geophysical data according to the present invention proposes to combine a new type of approach based on analysis, reproduction and interpretation techniques of the sound signals obtained from a musical multiscale transformation of geophysical signals, with the imaging and/or sonification techniques currently used. The method according to the invention guarantees an accurate transformation of the data, at the desired level of detail, in relation to the geophysical application to be effected. In other words, the geophysical signals are transformed into musical attributes with an accuracy that can vary in relation to the scale of the geophysical problem and detail to be reached. If, for example, the spectral content of the starting data includes high-frequency physical events, these physical events are faithfully reproduced in derivative sound attributes and correctly localized in space and/or time.

A transformation or sonification technique of the known type, which can be simply and immediately implemented, consists in conventionally associating the various amplitudes of the geophysical response with different musical notes. A seismogram, for example, can be virtually transposed onto a musical stave, associating a note whenever the seismogram intersects a line or a space. This technique therefore consists in a simple symbolic transposition of geophysical information into sound information. This technique does not take into account information in terms of the original signal frequency and simply transforms the amplitudes into sounds.

Another more advanced transformation or sonification technique of the known type, is based on a frequency analysis of the geophysical signal thanks to which the frequency spectrum of the geophysical signal itself can be transformed into musical notes. This result can be obtained, for example, by effecting the Fourier transform of the starting signal in time windows having a predetermined amplitude (STFT: acronym of “Short-Time Fourier Transform”).

These transformation techniques do not allow the time resolution required for musically analyzing the geophysical signals of interest in detail. A typical seismic signal of oil exploration, for example, can contain important events that fall within time ranges of a few milliseconds and which, at the same time, are characterized by a rich frequency content. When a physical signal originally represented as a time series of values, such as, for example, a seismic trace, is transformed in the frequency domain, the uncertainty principle imposes accuracy limits. Either a good accuracy is obtained in reproducing the frequency content or, alternatively, a good accuracy is obtained in the time localization of physical events. By effecting the STFT (“Short-Time Fourier Transform”), for example, in long time windows, a good accuracy is obtained in terms of frequency, but a bad time localization of interesting events. The opposite happens when the STFT is effected using small time windows.

The multimodal and multiscale analysis method of geophysical data according to the present invention allows the above limitations to be overcome, regulating the amplitude of the time window in which the transform is effected in relation to the frequency content of the original signal. In this way, a transformation is obtained with a variable scale and resolution depending on the requirements and geophysical data to be analyzed. The method is based on the use of other types of spectral decomposition, such as the Stockwell transform and analysis or wavelet transform. These techniques allow a signal to be transformed, which naturally evolves in the time or space domain into a representation in the frequency-time domain (STFT or Stockwell transform) or scale-time factor (Wavelet transform) using time windows that have a non-prefixed amplitude but that are variable in relation to the frequency content of the starting signal. Unlike the Fourier transform which is local in frequency but global in time, the techniques indicated above are local in both time and frequency. This approach ensures that the derivative sound attributes reproduce the physical characteristics of the starting signal with a high precision.

The multimodal and multiscale analysis method of geophysical data according to the present invention also allows the creation of unique musical attributes, in addition to the use of pattern recognition techniques for the automatic identification of geophysical-geological signals of particular interest, such as, for example, oil tanks, overpressurized geological layers, stratigraphic variations, etc.

There are numerous advantages offered by a multiscale transposition method of geophysical signals into the musical domain. It is known, for example, that the hearing ability and capacity of the cerebral cortex of integrating sounds into unitary cognitive structures and provided with sense can be greater than that of sight (and the visual cortex) in integrating images. Let us suppose, for example, that we would like to simultaneously take into account a series of thirty images of a seismic section decomposed into as many frequency components. A single image can obviously always be composed through the transparent overlay of thirty images obtained for each single frequency of the signal spectrum. The unitary perception of the resulting image, however, will be visibly impossible, or at least chaotic. If, on the other hand, the frequency spectrum of the same signal is adequately transformed into sound, with a high precision and accuracy, the sounds themselves can be composed into a single and faithful musical reproduction. Unlike superimposed images, many sounds can be simultaneously perceived as a cognitive structure having sense, i.e. a harmonic musical structure. With the multiscale transformation method, object of the present invention, the spectral decomposition of a signal can be heard in its whole frequency band, ensuring a high accuracy in the time and frequency localization of events.

Even with dissonances, which are inevitable in the case of sonification of geophysical signals, the human brain is structured so as to continuously search for musical patterns and structures. Pattern and musical structures can be extracted from the chaotic background of notes and immediately associated with geophysical objects of interest. This “pattern recognition” operation and classification can take place interactively, i.e. by direct interpretation, and also automatically, i.e. using “pattern recognition” instruments of sound.

The multimodal and multiscale analysis method of geophysical data according to the present invention is based on the principle according to which a geological object of interest, such as, for example, a palaeo-channel with hydrocarbons, when crossed by a field of waves of the seismic, electromagnetic, gravimetric, magnetic type, and even more, can have a characteristic and distinctive geo-musical response with respect to the background, i.e. the geological context in which the above geological object is inserted. As the specific feature of the geo-musical response is strictly correlated to the frequency response of the same geological object, one might think that a conventional frequency analysis could be sufficient for identifying possible signals of interest. In reality, although this observation is partially true, the transformation of the geophysical response into music has a series of advantages.

A first advantage consists in the possibility of simultaneously reproducing the whole frequency response through the implementation of a music file deriving from the geophysical signal. This simultaneous representation is not possible in terms of imaging. Furthermore, once the geophysical response has been transported into the digital music domain, it can be processed, reproduced and integrated using advanced methods and musical processing instruments (Paolo Dell'Aversana, “Listening to geophysics: Audio processing tools for geophysical data analysis and interpretation”, The Leading Edge, August 2013).

The analysis in the musical domain obviously does not exclude the possibility of effecting one or more traditional analyses in terms of imaging: the two types of analysis are not, in fact, reciprocally exclusive, but complementary.

The first phase of the method according to the invention therefore consists in transforming the geophysical and/or seismic data or signals into sound data, through a spectral analysis based on more advanced techniques, such as those, for example, based on a wavelet analysis or on the Stockwell transform. The spectrum of the seismic signal is processed after being transformed into a sound signal (in a digital audio format or MIDI). The processing consists in a type of processing of the signal which is effected with instruments generally used in the domain of digital music, such as, for example, equalizers, application of MIDI effects, audio effects, etc. The aim of this processing is to highlight those components of the spectrum which, after calibration and/or modelling, have been identified as characterizing the geophysical response associated with the type of target to be highlighted.

A further innovative aspect of the method according to the invention is to create particularly effective musical attributes using techniques normally applied in the field of digital music. The objective is to highlight the geophysical information of interest, once this has been transformed into sounds, with a high degree of accuracy.

Furthermore, the method according to the invention introduces the further innovation of identifying the sound signal of interest associated with a certain type of geophysical target not only by means of an interactive and global analysis of the sound, possibly accompanied by a more traditional visual analysis, but also using automatic “musical pattern recognition” techniques. In this way, the geophysical problem of recognizing geological-geophysical targets of interest is faced through an approach based on the recognition of characteristic multimodal signals, i.e. perceived with different senses, rather than (or in combination with) an inversion-based approach.

Finally, if other data of a non-seismic nature are available, such as, for example, electromagnetic, gravimetric or magnetometric data, the method according to the invention can also be extended to this data, integrating the whole data set in a multi-parametric geo-musical response. This approach of the multiphysical, multiscale and multimodal type definitely favours the identification and prediction of possible geophysical targets of interest. It is likely, in fact, that the presence of a geological object of interest, anomalous with respect to the background, may influence numerous physical parameters on a variable scale, such as, for example, the electrical resistivity, the dielectric constant, the electrical chargeability, etc.

The method according to the invention can be integrated with a multimodal and multiscale analysis system of geophysical data which operates in a virtual reality environment and which uses specific hardware supports. The idea is that a multimodal perception, i.e. visual and audible at the same time, of the geophysical signal can acquire greater effectiveness if it is in a totally “immersive” environment such as that offered by modern virtual reality technology.

The characteristics and advantages of a method and system for the multimodal and multiscale analysis of geophysical data according to the present invention can be summarized as follows:
multiscale transformation techniques of one or more geophysical signals into one or more musical signals (for example, transformations of the wavelet type or Stockwell type);
unique sound attributes useful for the characterization of geo-musical anomalies of interest (for example, combinations of MIDI parameters, tonal transposition of MIDI file, combination of MIDI tracks transposed differently, audio effects, distortions, equalizations, etc.);
innovative reproduction techniques and visual and audio comparative analysis of geo-musical signals (for example, running a MIDI file while a pointer (mouse) slides on an image on the screen and shows the corresponding spectrogram);
integration techniques of different types of geophysical signals transformed into sound attributes (for example, using virtual mixers or combinations of music clips);
pattern recognition techniques of the geo-musical signals and automatic interpretation, i.e. based on the automatic identification of patterns to be compared with a pre-constructed database.

The characteristics and advantages of a method and system for the multimodal and multiscale analysis of geophysical data according to the present invention will appear more evident from the following illustrative and non-limiting description, referring to the enclosed schematic drawings, in which:

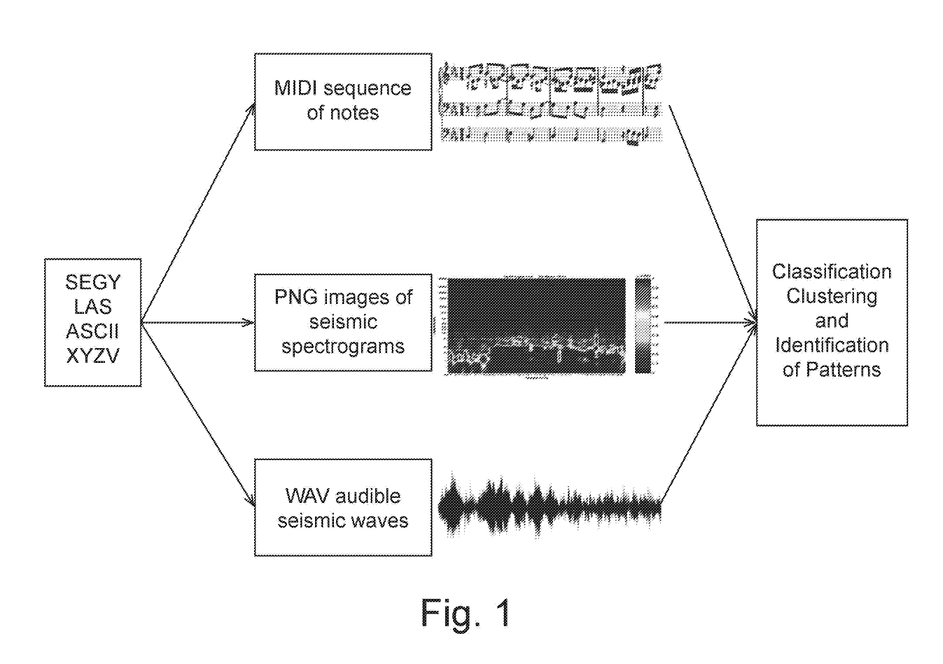

FIG. 1 is a diagram that schematizes the main steps of the multimodal and multiscale analysis method of geophysical data according to the present invention; and

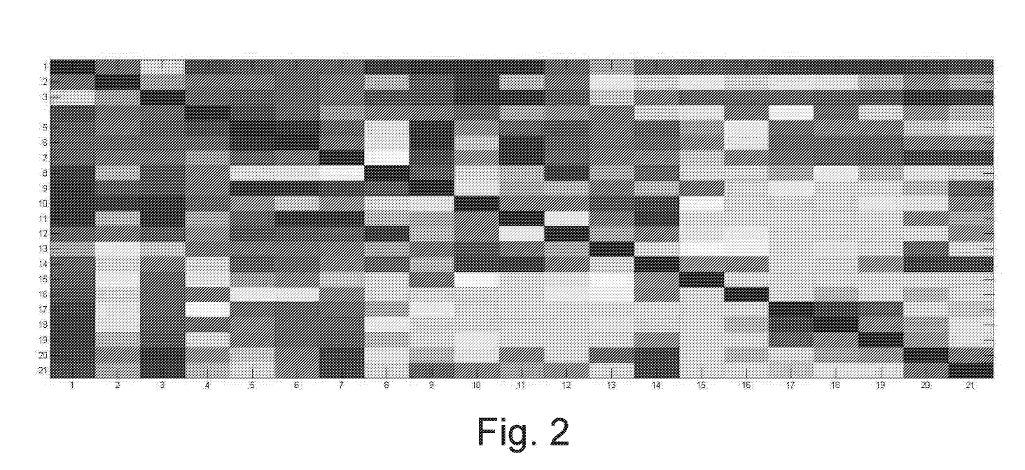

FIG. 2 is a dissimilarity matrix for preliminarily identifying, in the “pattern recognition” step of the method according to the invention, clusters of seismic traces having the same melodic characteristics (i.e. pitch of the notes) and/or rhythm (i.e. duration of notes).

With reference to the figures, these show a multimodal and multiscale analysis method of geophysical data according to the present invention. The first step of the method according to the invention consists in the acquisition, by means of techniques and systems known per se and described in greater detail hereunder, of a plurality of geophysical and/or seismic data or signals extracted from a predefined geological context or background.

The subsequent step then consists in transforming or converting the geophysical and/or seismic data or signals into corresponding sound data, wherein the latter are available in standard digital musical formats. The geophysical data or signals to which reference is made in the present description can consist, for example, of various types of attributes of a seismic nature, geophysical well logs, gravity data and their attributes, magnetic field and electromagnetic field data and their attributes, and so forth. From an algorithmic point of view, what differentiates the transformation for the various types of geophysical data or signals is the different acquisition and extraction process of the portion of signal of interest, whereas what is in common is the conversion process of the signal into the desired musical format (typically WAV or MIDI).

The seismic data that are processed and transformed into musical format can relate to two-dimensional seismic sections (2D), three-dimensional volumes (3D) and data acquired with the VSP method that envisages, in the most common application, seismic sources at the surface and accelerometer or velocimeter sensors positioned inside a well. SEG-Y is the most common file format used for registering geophysical and/or seismic data in the oil industry. The following information can be extracted from a file in SEG-Y format:
a) one or more seismic traces extracted on a time window chosen by a user;
b) constant time section to, also called “time slice”, which runs through the entire seismic section or a part of it, constructed by extracting the amplitudes of each seismic trace in a time defined by the user;
c) constant time section to, which runs through the entire seismic section, constructed by preferably calculating the geometrical average (but other operators may also be used) of the amplitudes within a time window defined by the user around the constant time to;
d) variable time section t(r), wherein r is the vector which identifies the coordinates that span the seismic section or a portion thereof, obtained by extracting the seismic amplitudes along a horizon that defines a seismic reflection event;
e) variable time section t(r), constructed by preferably calculating the geometrical average (but other operators may also be used) of the amplitudes within a time window defined by the user around the variable time t(r);
f) horizontal seismic range, obtained by extracting amplitudes included within two horizons at variable time t₁(r) and t₂(r) defined by the user, with t₂(r)>t₁(r). For each r, at the amplitudes included within t₁(r) and t₂(r), the geometrical average is preferably applied (but other operators may also be used).

The types of data extracted according to the procedures indicated in items a) to f) are transformed in a vector, which is indicated hereunder as v. A system is to be created which is capable of reproducing, in real time, a file in MIDI or WAV format relating to an observed portion of two-dimensional seismic section (2D) or three-dimensional seismic volume (3D).

If the geophysical data consist of geophysical well logs, said geophysical data are usually memorized in LAS (acronym of “Log ASCII Standard”) format. Said LAS format envisages the storage in ASCII format of various types of data: Gamma Ray, Resistivity (all the various types present on the market), Spontaneous Potential, Induction, Sonic, Formation Density, Neutron, Temperature, Electromagnetic Propagation, Photo Electric Absorbition (Absorption ?) Factor, Thermal Decay Time, Caliper, etc. As each type of datum has already been memorized as a file in ASCII format, a specific application program allows one of the logs of interest to be extracted from the LAS file over a depth range defined by the user and stored in the vector v.

If the geophysical data consist of gravimetric, magnetometric and electromagnetic data, said geophysical data can be available in ASCII Zycor or XYV formats (wherein “V” stands for “value”). Two-dimensional signals are extracted from the magnetic, electromagnetic or gravimetric field maps, and also from the maps deriving therefrom (for example, after the application of edge detectors or various kinds of filterings), with a spatial extension defined by the user, to be memorized in the vector v.

The geophysical and/or seismic data or signals are transformed into sound data, in WAV format or directly into MIDI format, using codes specifically written for this purpose.

The WAV format envisages the selection of a sampling frequency f_{c} to be attributed to the signal represented by the vector v. The sampling frequency f_{c} to be used is preferably equal to 44.1 kHz. If the vector v has a size equal to n, the time duration T of the WAV file obtained from the simple conversion of the vector v is equal to:

$$T = \frac{n}{{f}_{c}} .$$

As n is generally <10,000, T is <0.3 seconds. In order to increase the duration of the signal, an interpolation is effected on the vector v by a factor k, so that a new length of the vector v is equal to k*n. Therefore, the new time duration T′ becomes equal to:

$${T}^{′} = \frac{k \times n}{{f}_{c}} .$$

The following criteria are adopted for selecting the interpolation factor:
an arbitrary factor is applied so that the resulting WAV file is sufficiently long and is in a band of frequencies audible to the human ear;
if the vector v comes from the extraction of seismic traces (item a) of the previous list), as these have a time evolution due to their very nature, an interpolation factor can be selected which is such that the duration of the resulting WAV file is equal to that of the original trace. In particular, in order to satisfy this condition, it is necessary for:

k=f_{c}×Dt,

wherein Dt is the temporal sampling pitch of the seismic trace.

The nature of the data being written is one of the main keys of the present invention. It was decided to decompose the signal contained in the vector v using specific instruments for the time-frequency analysis of the non-stationary signals, such as STFT (“Short-Time Fourier Transform”), wavelet analysis or transform and Stockwell transform, also called transform-S.

STFT (“Short-Time Fourier Transform”) is a short-term Fourier transform, whose formulation for time-continuous signals is the following:

X(τ,ω)=∫_{-∞}^{∞}x(t)ψ=(t−τ)dt

wherein x(t) is the non-stationary signal, consisting in this case of one or the geophysical signals mentioned above, Ψ(t) is the time window on which the transform acts, whereas τ is the time instant around which the signal spectrum is evaluated. As Ψ(t) is preferably of the Gauss type (but it can also be of another type), it can also be called Gabor transform. The calculation of the STFT returns a spectrogram, i.e. a representation in the time-frequency domain of signal.

STFT is a technique which, by envisaging a time window having a constant width, has a constant frequency resolution. This is a consequence of the uncertainty principle, according to which the temporal and harmonic characteristics of a time series cannot be determined with arbitrary precision. Consequently, by adopting a wide time window, a good frequency resolution but a low time resolution are obtained, and viceversa.

The wavelet analysis or transform allows a multiscale analysis of the signal to be effected with an improved localization capacity in time and frequency of the events with respect to STFT. The formulation of the wavelet analysis or transform for time-continuous signals is the following:

$$[ {W}_{ψ} x ] ( a , b ) = \frac{1}{\sqrt{a}} {\int }_{- ∞}^{∞} x ( t ) ψ ( \frac{t - b}{a} ) dt$$

wherein x(t) is the non-stationary geophysical datum or signal, Ψ(t) is the mother wavelet, a is the expansion of the wavelet (scale factor) and b is the time shift factor of the wavelet. The following mother wavelet is preferably used:

ψ(t)=(1−t²)e^{-t}^{²}^{/2}

which corresponds to the second derivative of a Gaussian curve. This type of wavelet guarantees an excellent localization in time and frequency (Akansu, 2001), but other kinds of wavelets can also be used, such as Morlet (reference). The above transform produces a decomposition of the signal in the time-scale factor plane. As can be noted from the formulation of the Wavelet transform indicated above, the frequency does not appear. The frequency can be obtained by means of a linear “scale factor-frequency” relation which leads back to the spectrogram.

Analogously to the wavelet transform, the Stockwell transform also offers the possibility of effecting a multiscale analysis. The formulation in time-continuous regime of the Stockwell transform is the following:

$$S ( τ , f ) = \frac{1}{σ ( f ) \sqrt{2 π}} {\int }_{- ∞}^{∞} x ( t ) {e}^{- i 2 π f t} {e}^{- \frac{{( t - τ )}^{2}}{2 {σ}^{2} ( f )}} dt$$

$$with σ ( f ) = \frac{1}{\vert f \vert} .$$

It can be noted that this is a particular case of STFT with a Gaussian-type window, whose standard deviation is in relation to the frequency. At low frequencies, the time window is wide and with a low amplitude, whereas for high frequencies the time window is narrow and with a high amplitude. This guarantees an optimum localization in the time-frequency domain of the contributions in both low and high frequency. In other words, the Stockwell transform guarantees a multiscale resolution like the wavelet transform, with the advantage of maintaining the link with the frequency as STFT.

The use is envisaged of a generalized version of the Stockwell transform, expressed as follows:

σ(f)=g(t,|f|^{α})

with α<0, in order to obtain a multiscale resolution adapted to the characteristics of the geophysical signal of interest.

Once the conversion has been effected of the geophysical and/or seismic data or signals into sound data, identified with standard musical formats, another step of the multimodal and multiscale analysis method of geophysical data according to the present invention consists in creating sound attributes useful for a better identification and characterization of geo-musical anomalies of interest. These sound attributes can be easily obtained using specific electronic and/or software instruments, such as, for example, sequencers of the commercial type. The innovative nature of this phase of the method lies in the unique application of these electronic and/or software instruments for creating particular MIDI and/or sound attributes associated with geophysical data or signals. These sound attributes can be obtained in one or more of the following ways:
frequency transposition of the sound data, in the MIDI format, deriving from the geophysical signal, so as to transport the sound information to a hearing band particularly favourable for listening;
combination of several MIDI tracks deriving from the same starting geophysical signal, but differently transposed. In this way, each minimum geophysical signal is translated into a chord. The chord is preferably of a consonant nature, effecting transpositions for third, fifth and eighth musical intervals, so as to obtain a harmonic result which is more pleasant to the ear and more easily perceptible;
application to the sound data of MIDI and/or audio effects, such as, for example, distorsions, equalizations, etc., suitable for highlighting particular characteristics of interest in the geophysical signal;
slowing down and/or acceleration of the implementation of MIDI tracks, so as to musically highlight details and/or structures of interest present in the geophysical data which cannot be easily recognized in the original signals.

A further step of the multimodal and multiscale analysis method of geophysical data according to the present invention consists in effecting an audio-video comparative analysis so as to associate with one or more images of a certain geophysical signal, one or more sounds associated with said images. This step, therefore comprises a preliminary step for converting geophysical and/or seismic data or signals, stored in files in SEG-Y format, into corresponding digital images. The audio-video comparative analysis can be effected through the following exclusive or complementary techniques:
automatic execution, at a velocity defined by the user, of a certain MIDI file while a mouse slides on a corresponding image shown on a screen. In this way, it is possible, for example, to listen to the sound associated with a seismic “time slice” observing the mouse sliding along a leader line of interest;
selection on a video, by means of a mouse, of a portion of image relating to a geophysical signal of interest and listening in real time to the sounds associated with said portion of image;
application of any other technique that allows anomalies of interest to be isolated (in 1D, 2D or 3D) on a certain image and to listen to the resulting sound through the transformations described above;
simultaneous visualization on predefined areas of an image of a seismic signal (for example, along a preselected seismic horizon), of its spectrogram, of the MIDI file in “piano roll domain” and listening to the associated sounds. “Piano roll domain” means a type of musical representation which makes use of a virtual keyboard. This virtual keyboard is provided together with numerous commercial packages, called sequencers, which manage MIDI and audio files in general.

A further step of the multimodal and multiscale analysis method of geophysical data according to the present invention, consists in the combination and simultaneous representation of different types of audio tracks (MIDI) associated with different types of geophysical signals. This step can be effected using virtual mixers or combinations of musical clips. Various types of geophysical signals of the seismic, gravimetric, electromagnetic type, for example, that affect the same area (defined on a map or in terms of volumetric attributes) can be combined with each other, once the signals themselves have been transformed into MIDI format. Each MIDI track defines a real musical clip. The various musical clips associated with different geophysical signals can be easily combined, easily defining real “musical scenes”.

With this step of the method, it is therefore possible to create different representations of complex images, each relating to a certain type of geophysical signal (seismic, electromagnetic or of a different type). Once a direction of interest has been selected, for example, a certain seismic horizon, the various complex images activated along said horizon can be represented simultaneously and played together, using different tracks of a virtual mixer. In this way, a complex multi-parametric and multimodal image is obtained, which includes various geophysical responses.

A final step of the multimodal and multiscale analysis method of geophysical data according to the present invention, consists in identifying geo-musical patterns through destructuring of geophysical data or signals. The identification of geo-musical patterns can be effected on at least one of the musical formats (WAV, MIDI) and/or images (PNG or another) obtained through the previous steps of the method.

Geophysical signals converted into audio signals in WAV and MIDI format, and also into images (in PNG format, for example) are analyzed through an automatic learning procedure aimed at extracting sound and/or visual patterns and attributing a geological meaning to said patterns. The images are obtained from the time-frequency analysis effected through Short Time Fourier Transform (STFT), Stockwell transform and analysis or wavelet transform methods.

As shown in FIG. 1, which schematically summarizes the main steps of the method according to the invention, the analysis of the datum or geophysical signal is effected through a destructuring of the geophysical signal itself, i.e. through a transformation of the datum or geophysical signal into audio contents (WAV signal), symbolic contents (MIDI signal) and visual contents (PNG signal). This decomposition of the geophysical signal has the advantage of widely enlarging the informative content of the signal itself.

Once the destructuring of the data or geophysical signals has been effected, the step for identifying geo-musical patterns comprises a first sub-step aimed at contemporaneously extracting, from the musical data (MIDI and WAV files) and from the visual data (PNG file), certain specific characteristics, i.e. unique audio, symbolic and visual attributes, which contribute to the general delineation of the geophysical signals of the system (for example seismic data). Said sub-step for the extraction of specific characteristics from different kinds of files has proved to be particularly advantageous as it allows various characteristics to be extracted from said files, which cannot be easily extracted from a single format with respect to another.

As far as MIDI files are concerned, the characteristics that can be extracted relate to attributes of a statistical nature deriving from pitches (or heights) that are linked to the frequency of the notes, the time duration of the notes, the triggering time of the notes and the velocity of the same notes. This latter attribute can be attributed to the amplitude of the sound of the notes. With respect to WAV files, the characteristics that can be extracted relate to attributes of a statistical nature deriving from an analysis of the dynamic nature of the signal, its “cepstrum” and its frequency spectrum, or from a suitable combination of all of these attributes. As far as PNG files are concerned, the characteristics that can be extracted relate to attributes deriving from the field of computer vision, such as, for example, descriptors of the delineation of the form of some specific patterns, the colour gradient, colour, space envelopment and texture.

A second sub-step of the identification step of geo-musical patterns comprises the classification of the characteristics obtained through the first sub-step. The classification is effected by means of automatic learning and form recognition techniques. In particular, various techniques can be used for this purpose, depending on the application.

Supervised learning techniques can be used for distinguishing areas, in a seismic field for example, from the different stratigraphic characteristics. The groups into which the problem can be divided can be established either by visual comparison of the image deriving from the seismic data, or they can be previously obtained on the basis of the extraction, from MIDI files alone (for reasons of limited computing calculation), the probability of occurrence of pitches, duration of the notes and velocity of the notes for each single seismic trace.

This second sub-step envisages the construction of a dissimilarity matrix (see FIG. 2) by means of a comparison of the above probabilities of occurrence through suitable measurements (Minkowsky and Mahalanobis distances, for example).

Non-supervised learning techniques can be used for distinguishing, stratigraphic areas, in a seismic field for example, from the different characteristics so that it can be independent from any assumption as to the number of groups into which the seismic traces can be preliminarily divided.

Semi-supervised learning techniques can instead be used, for example by means of the preliminary interpretation of well logs, for distinguishing traces from the different stratigraphic characteristics when, for example, the stratigraphy is only known in a limited portion of said traces. In this case, the learning is mixed as the traces whose stratigraphy is well-known, have the purpose of guiding the classification, without substantially modifying, however, the automatic and non-supervised search for patterns.

A third sub-step of the identification step of geo-musical patterns, which can be effected alternatively or in sequence with respect to the second sub-step, envisages the creation of sound patterns through the transformation of the musical data into representations or alphanumeric sequences on strings which contain at least one of the following items of information: pitch of the notes, velocity of the notes and duration of the notes. Preferably, this third sub-step can be effected on MIDI files alone for reasons of lower computing costs, versatility and wealth of frequency content.

Once the geophysical patterns have been transformed into these alphanumeric sequences, they can be represented as sequences of notes having a length which is not necessarily prefixed. The geological interpretation, for example of a seismic section that has migrated with time through traditional processing, is at this point crucial in defining the exact triggering and closure times of the sound pattern that can be associated with the geophysical pattern. This geological interpretation can be assisted by the direct listening of the tracks and information coming from the well logs. In other words, the creation of these geophysical sound patterns and their alphanumeric representation in various uniquely classified groups are effected initially guided on as wide a number as possible of seismic sections or portions of seismic sections. If a sufficiently high number of geophysical patterns is not available, new patterns (called “offspring” patterns) can be created by applying suitable crossover and mutation operators (in the language of the calculation of genetic algorithms) to the alphanumeric sequences preferably obtained from MIDI files, provided the Levenshtein distances between the original pattern identified by the geologist and those created artificially are included within a prefixed threshold and provided the fitness function of the patterns created artificially reflect some specific characteristics of the original pattern.

Finally, a fourth and last sub-step of the identification step of geo-musical patterns comprises identification of the sound patterns obtained in the previous sub-step, and also respective “offspring” patterns identified, for example, in other unexplored and/or completely new seismic sections.

The multimodal and multiscale analysis method of geophysical data according to the present invention can have various applications in the geophysical field. The method can be used, for example, for identifying overpressurized geological layers. The basic idea is that a geological layer saturated to a certain degree with overpressurized fluids can resonate in a specific way, wherein the meaning of the term “resonate” is explained hereunder. This is basically a concept similar to that of a sound produced by a container when is it shaken, wherein the sound varies in relation to the contents of the same container. If the contents consist of a pressurized fluid, the typical sound will be different from that produced under normal conditions, i.e. without pressurized fluid. Consequently, a geological layer, such as, for example, a clay formation, that is in overpressure conditions, can respond with a Characteristic Complex Sound or CCS to an artificially induced seismic action. The expression Characteristic Complex Sound refers to a musical response, inclusive of all its frequency components, simultaneously analyzed within a wide offset range. As a general principle, this concept is supported by the theory of elasticity and numerous synthesis and laboratory tests (José M. Carcione and Umberta Tinivella, “The seismic response to overpressure: a modelling study based on laboratory, well and seismic data”, Geophysical Prospecting, 2001, 49, pages 523-539).

Finally, if other data of a non-seismic nature are also available, such as, for example, electromagnetic data, the method according to the invention can also be extended to said data, integrating the whole data set in a multi-parametric geo-musical response. This approach of the multiphysical type definitely favours the identification and prediction of possible overpressurized layers. It is probable, in fact, that the presence of fluids under anomalous pressure conditions can have an influence on numerous physical parameters such as, for example, the electrical resistivity, the dielectric constant, the electrical chargeability, etc.

The method according to the invention can also be used, for example, for identifying accumulations of hydrocarbons. With an approach similar to that described for indentifying overpressurized geological layers, it can be expected that a geological target of interest, such as, for example, a palaeo-channel with hydrocarbons, when crossed by a field of waves of the seismic, electromagnetic, gravimetric, magnetic type, etc., can have a characteristic and distinctive geo-musical response with respect to the background, i.e. the geological context in which said target is inserted.

The method according to the invention can in any case also be used for other applications, such as, for example, the detection of gas hydrates, the discrimination of seismic facies, AVO (acronym of “Amplitude Versus Offset” or “Amplitude Variation with Offset”) sound analysis, seismic “time-lapse” sound analysis (4D), etc.

Finally, in order to insert the method described above in a totally “immersive” interpretative context and with multi-user cooperation, the same method can be implemented in a virtual reality multimodal and multiscale analysis system of geophysical data through the transformation of said geophysical data into musical attributes. In this way, the integrated reproduction and comparative visual and sound analysis of the geo-musical signal can be optimized, drawing benefits from the most modern virtual reality technology.

Once the significant sound attributes have been extracted from a starting geological-geophysical datum, it becomes possible to implement the sound component, complementary to the visual component, in an interactive and totally immersive instrument, such as, for example, a virtual reality helmet. When wearing this helmet, the user is instantaneously projected into a virtual reality consisting not only of images but also of sound attributes physically connected to the same images. The cognitive effect is that of an extension of the cerebral functions involved in the analysis and interpretation experience of the geological-geophysical datum. This “increased” cognitive activity can be monitored in real time using appropriate sensors, implemented in the same helmet, for achieving one or more neuro-imaging techniques.

More specifically, the multimodal and multiscale analysis system of geophysical data according to the present invention can also comprise, in addition to the above virtual reality helmet, a central processing unit provided with the following characteristics:
a software configured for effecting format transformations (from SEG-Y to WAV, from SEG-Y to MIDI, from WAV to MIDI, etc.) of the files corresponding to all of the geophysical signals of interest, each of said files being produced through specific algorithms and procedures;
a database containing all of the geo-musical responses in a specific area of interest;
one or more software configured for effecting the visual and sound analysis of the information;
a software configured for effecting a musical pattern recognition using said database, so that the association between geophysical data and musical patterns occurs through an automatic search based on sound pattern recognition algorithms;
a software configured for effecting the categorization and final interpretation of the geo-musical signals associated with the geological-geophysical targets of interest.

As for the virtual reality helmet, this is operatively connected to the central processing unit and is provided with a specific representation and audio-visual analysis software of all of the information (images and sound attributes) processed and managed by said central processing unit. The helmet is therefore configured, by means of an appropriate hardware and software system, for being inserted in an interactive network of multisensory helmets aimed at teamwork in a totally “immersive” audio-visual virtual reality environment.

It can thus be seen that the method and system for the multimodal and multiscale analysis of geophysical data according to the present invention achieve the objectives previously specified.

The method and system for the multimodal and multiscale analysis of geophysical data according to the present invention thus conceived can in any case undergo numerous modifications and variants, all included in the same inventive concept. The protection scope of the invention is therefore defined by the enclosed claims.

1. A multimodal and multi-scale analysis method for analysing geophysical data, the method comprising:
acquiring a plurality of geophysical and/or seismic data or signals extracted from a predefined geological context;
recording said geophysical and/or seismic data or signals in a digital format on a vector (v);
transforming or converting said geophysical and/or seismic data or signals contained in said vector (v) into corresponding digital images;
transforming or converting the geophysical and/or seismic data or signals contained in said vector (v) into corresponding sound data, wherein said sound data are made available in standard digital musical formats and wherein said geophysical and/or seismic data or signals contained in said vector (v) are processed as a function of time and of relative frequency content;
creating sound attributes suitable for identifying and characterizing specific geo-musical anomalies starting from said sound data; and
performing an audio-video comparative analysis so as to associate one or more of said sound data with one or more of said digital images of a certain geophysical signal.

2. The method according to claim 1, wherein the processing as a function of the time and of the relative frequency content of said geophysical and/or seismic data or signals contained in said vector (v) is performed according to the following short-term Fourier transform:
X(τ,ω)=∫_{-∞}^{∞}x(t)ψ(t−τ)dt
wherein x(t) is a non-stationary geophysical datum or signal, Ψ(t) is a time window on which the transform acts, τ is a time instant around which a signal spectrum is evaluated.

3. The method according to claim 1, wherein the processing as a function of the time and of the relative frequency content of said geophysical and/or seismic data or signals contained in said vector (v) is performed according to the following analysis or wavelet transform:
$$[ {W}_{ψ} x ] ( a , b ) = \frac{1}{\sqrt{a}} {\int }_{- ∞}^{∞} x ( t ) ψ ( \frac{t - b}{a} ) dt$$
wherein x(t) is a non-stationary geophysical datum or signal, Ψ(t) is a mother wavelet, a is an expansion of the wavelet and b is a time shift factor of the wavelet.

4. The method according to claim 3, wherein the mother wavelet consists of:
ω(t)=(1−t²)e^{-t}^{²}^{/2}
which corresponds to a second derivative of a Gaussian curve.

5. The method according to claim 1, wherein the processing as a function of the time and of the relative frequency content of said geophysical and/or seismic data or signals contained in said vector (v) is performed according to the following Stockwell transform:
$$S ( τ , f ) = \frac{1}{σ ( f ) \sqrt{2 π}} {\int }_{- ∞}^{∞} x ( t ) {e}^{- i 2 π f t} {e}^{- \frac{{( t - τ )}^{2}}{2 {σ}^{2} ( f )}} dt$$
$$with σ ( f ) = \frac{1}{\vert f \vert} or σ ( f ) = g ( t , {\vert f \vert}^{α} ) , α < 0.$$

6. The method according to claim 1, further comprising:
combining different types of sound data associated with different types of geophysical signals, so as to create different representations of complex images, each relating to a certain type of geophysical signal, said complex images being simultaneously represented and played together to obtain a multi-parametric and multimodal complex image which includes different geophysical responses.

7. The method according to claim 1, further comprising:
identifying geo-musical patterns by deconstruction of the geophysical data or signals.

8. The method according to claim 7, wherein said identifying of the geo-musical patterns comprises:
extracting certain specific characteristics from the sound data and the digital images, which contribute to a basic delineation of the system of geophysical signals;
classifying the characteristics obtained through said extracting by performing through at least one automatic learning and form recognition technique;
creating, alternatively or in sequence with respect to said classifying, sound patterns through transformation of the musical data into representations or alphanumeric sequences on strings which contain at least one of the following information: pitch of notes, velocity of the notes and duration of the notes; and
identify the sound patterns obtained in said creating of sound patterns.

9. The method according to claim 8, wherein
said at least one automatic learning and form recognition technique comprises:
a supervised learning technique;
a non-supervised learning technique; and
a semi-supervised learning technique, and
said said at least one automatic learning and form recognition technique is associated with construction of a dissimilarity matrix which compares probabilities of occurrence, for each seismic trace, of the pitch of the notes, of the velocity of the notes and of the duration of the notes through suitable measurements.

10. The method according to claim 1, wherein said sound data consist of files in WAV or MIDI digital format.

11. The method according to claim 10, wherein said sound attributes suitable for identifying and characterizing specific geo-musical anomalies are obtained through one or more of the following manners:
frequency transposition of the sound data, in the MIDI format, deriving from the geophysical signal, so as to transport the sound information to a hearing band favourable to listening;
combination of several MIDI tracks deriving from the same starting geophysical signal, but differently transposed, so that each minimum geophysical signal is traduced into a chord;
application to the sound data of MIDI and/or audio effects suitable for enhancing characteristics of interest in the geophysical signal; and
slowing down and/or acceleration of execution of the MIDI tracks, so as to musically highlight details and/or structures of interest present in the geophysical data which are easily recognized in original signals.

12. The method according to claim 10, wherein said audio-video comparative analysis is performed through the following exclusive or complementary techniques:
automatic execution at a predefined velocity of a certain MIDI file while a pointer slides on a corresponding image shown on a video, so as to listen to the sound associated with a seismic “time slice” observing the pointer sliding along a leader line of interest;
selection on a video, via a pointer, of a portion of image relating to a geophysical signal of interest and listening in real time of the sounds associated with said portion of image; and
simultaneous visualization on predefined areas of an image of a seismic signal, of its frequency spectrum, of the MIDI file and listening of the associated sounds.

13. The method according to claim 1, wherein said geophysical and/or seismic data or signals consist of files in a SEG-Y digital format containing the following information:
one or more seismic traces extracted on a time window selected by a user;
constant time (t₀) section, which crosses an entire seismic section or a part thereof, constructed by extracting amplitudes of each seismic trace at a time defined by the user;
constant time (t₀) section, which crosses the entire seismic section or a part thereof, constructed by optionally calculating the geometric average of the amplitudes comprised in a time window defined by the user around the constant time (t₀);
variable time t(r) section, wherein r is a vector that identifies the coordinates spanning the seismic section or a portion thereof, obtained by extracting the seismic amplitudes along a horizon identifying a seismic reflection event;
variable time t(r) section, constructed by optionally calculating the geometric average of the amplitudes comprised in a time window defined by the user around the variable time t(r); and
horizontal seismic interval obtained by the extraction of amplitudes comprised between two variable time t₁(r) and t₂(r) horizons defined by the user, with t₂(r)>t₁(r), wherein, for each r in the amplitudes comprised between t₁(r) and t₂(r) the geometric average is optionally applied.

14. A multimodal and multi-scale analysis system of geophysical data which implements the method according to claim 1, said system comprising:
a central processing unit comprising:
a software configured for performing format transformations of files corresponding to all of the geophysical signals of interest, each of said files being made through specific algorithms and procedures;
a database containing all geo-musical responses in a specific area of interest;
one or more software configured for performing the visual and sound analysis of the information;
a software configured for performing a musical pattern recognition using said database, so that association between geophysical data and musical patterns occurs through an automatic search based on sound pattern recognition algorithms;
a software configured for performing categorization and final interpretation of the geo-musical signals associated with geological-geophysical targets of interest; and
at least one virtual reality helmet, operatively connected to said central processing unit and comprising a representation and audio-visual analysis software of all of the information processed and managed by said central processing unit.

15. The system according to claim 14, wherein the helmet is configured, through an own specific hardware and software system, for being inserted into an interactive network of multisensory helmets aimed at teamwork in a totally “immersive” audio-visual virtual reality environment.
